(19) United States
(12) Patent Application Publication
(10) Pub. No.: US 2014/0337774 A1
(43) Pub. Date: Nov. 13, 2014

(54) Proxy for Sorting and Navigating Cards

(71) Applicant: ADOBE SYSTEMS INCORPORATED, San Jose, CA (US)

(72) Inventors: Ryan S. Baarz, Provo, UT (US); Daren G. Reavis, Spanish Fork, UT (US); Cameron R. Cowan, Provo, UT (US); Matthew J. Aune, Salt Lake City, UT (US)

(73) Assignee: Adobe Systems Incorporated, San Jose, CA (US)

(21) Appl. No.: 13/890,071

(22) Filed: May 8, 2013

(51) Int. Cl. G06F 3/0486; G06F 3/0484

(52) U.S. Cl. CPC G06F 3/0486; G06F 3/04842
USPC 715/769

(57) ABSTRACT

A user interface includes one display area in which a set of cards is displayed and another display area in which a set of proxies is displayed. Each card includes content that can be displayed, although not all of the cards can be displayed concurrently. Each proxy in the set of proxies corresponds to one of the cards in the set of cards, including the subset of cards that is displayed at any one time as well as the cards that are not displayed. The set of proxies can be used to sort and navigate the cards in the set of cards in various manners, including dragging and dropping a proxy to change the order of the proxies and the corresponding cards, selecting one of the proxies to display the corresponding card, and displaying a name or other information for a card when hovering over the corresponding proxy.

### BACKGROUND

As computing devices have evolved, various different user interfaces for displaying data have been developed. One type of user interface displays multiple different groupings of content, such as widgets, in one area with different groupings of content being displayed at different times. Although such user interface displays can be useful, they are not without their problems. One such problem is that selecting which groupings of content are to be displayed at various times can be burdensome on the user, leading to unpleasant user experiences.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

In accordance with one or more aspects, a first subset of a set of cards is displayed in a first display area of a user interface in a particular order relative to one another. A set of proxies is displayed in a second display area of the user interface in a particular order relative to one another. Each proxy corresponds to a card of the set of cards and the set of proxies includes a proxy for each card in the set of cards. A user input is received to change a location of one of the proxies in the particular order in the second display area. In response to the user input, the particular order of the first subset of cards in the first display area is changed based on the changed location of the one proxy. Also in response to the user input, the particular order of the set of proxies displayed in the second display area is changed.

In accordance with one or more aspects, a subset of cards of a set of cards is displayed in a first display area of a user interface in a particular order relative to one another. A set of proxies is displayed in a second display area of the user interface in a particular order relative to one another. Each proxy corresponds to one of the set of cards and the set of proxies includes a proxy for each card in the set of cards. A user input dragging and dropping one of the proxies in the set of proxies to a different location in the particular order in the second display area is received. In response to the user input, the cards in the first display area are sorted so that the card corresponding to the one proxy is in a same location relative to the other cards of the set of cards as the one proxy is relative to the other proxies of the set of proxies.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example computing device implementing the proxy for sorting and navigating cards in accordance with one or more embodiments.

FIG. 2 is a flowchart illustrating an example process for implementing the proxy for sorting and navigating cards in accordance with one or more embodiments.

FIGS. 3 and 4 illustrate example user interfaces displaying areas for proxies and cards in accordance with one or more embodiments.

FIGS. 5 and 6 illustrate example user interfaces displaying information regarding a card corresponding to a proxy being hovered over in accordance with one or more embodiments.

FIG. 7 illustrates an example user interface displaying a proxy that is dragged and dropped to a new location in accordance with one or more embodiments.

FIG. 8 illustrates an example user interface displaying a proxy that has been dragged and dropped to a new location in accordance with one or more embodiments.

FIG. 9 illustrates another example user interface displaying a proxy that is dragged and dropped to a new location in accordance with one or more embodiments.

FIG. 10 illustrates another example user interface displaying a proxy that has been dragged and dropped to a new location in accordance with one or more embodiments.

FIG. 11 illustrates an example user interface displaying a card that is dragged and dropped to a new location in accordance with one or more embodiments.

FIG. 12 illustrates an example user interface displaying a card that has been dragged and dropped to a new location in accordance with one or more embodiments.

FIG. 13 illustrates an example user interface displaying a card that has been navigated to in accordance with one or more embodiments.

FIG. 14 illustrates an example system that includes an example computing device that is representative of one or more computing systems and/or devices that may implement the various techniques described herein.

### DETAILED DESCRIPTION

A proxy for sorting and navigating cards is discussed herein. A user interface includes one display area in which a set of cards (also referred to as widgets) is displayed, and another display area in which a set of proxies is displayed. A card is a collection or grouping of data or content that can be displayed. The data or content is oftentimes displayed within a boundary or container (e.g., having a rectangular or other geometric shape) to facilitate a user distinguishing different collections of data or content from one another, although the boundary or container can alternatively be hidden (not displayed). The data or content can take different forms, such as a static image that is displayed, a collection of data or content that can change over time, and so forth.

A proxy is a representation of a card that can be displayed with typically smaller size than the card. Each proxy corresponds to or represents a card in the set of cards, and one proxy is displayed for each card in the set of cards. Each proxy can be displayed in various forms, such as the outline of a geometric shape (e.g., the same shape as the boundary or container in which the content of the corresponding card is displayed), a geometric shape filled with a particular pattern, an icon or image, and so forth.

Each card includes various information or content that can be displayed, although given the size and quantity of the cards, not all of the cards in the set of cards can be displayed concurrently. Each proxy in the set of proxies corresponds to one of the cards in the set of cards, including the subset of cards that is displayed at any one time as well as the cards that are not displayed. The proxies are displayed in a particular order relative to one another, and the corresponding subset of cards are displayed in the same order relative to one another. The set of proxies can be used to sort and navigate the cards in the set of cards in various manners.

A user input that drags and drops a proxy can be received, resulting in a change in the order of the proxies. If the user changes the order of the proxies, the corresponding cards are sorted so that the order of the corresponding cards is changed analogous to the change in order of the proxies. Similarly, if the user changes the order of the cards, the corresponding proxies are sorted so that the order of the corresponding proxies is changed analogous to the change in order of the cards.

A user input that selects one of the proxies (e.g., double clicking on one of the proxies) can also be received. In response to such a user input, the subset of cards that is displayed is changed as appropriate so that the card corresponding to the selected proxy is displayed.

A user input that is a hovering (e.g., of a pointer or cursor) over one of the proxies can also be received. In response to such a user input, a name and/or other information regarding the corresponding card is displayed.

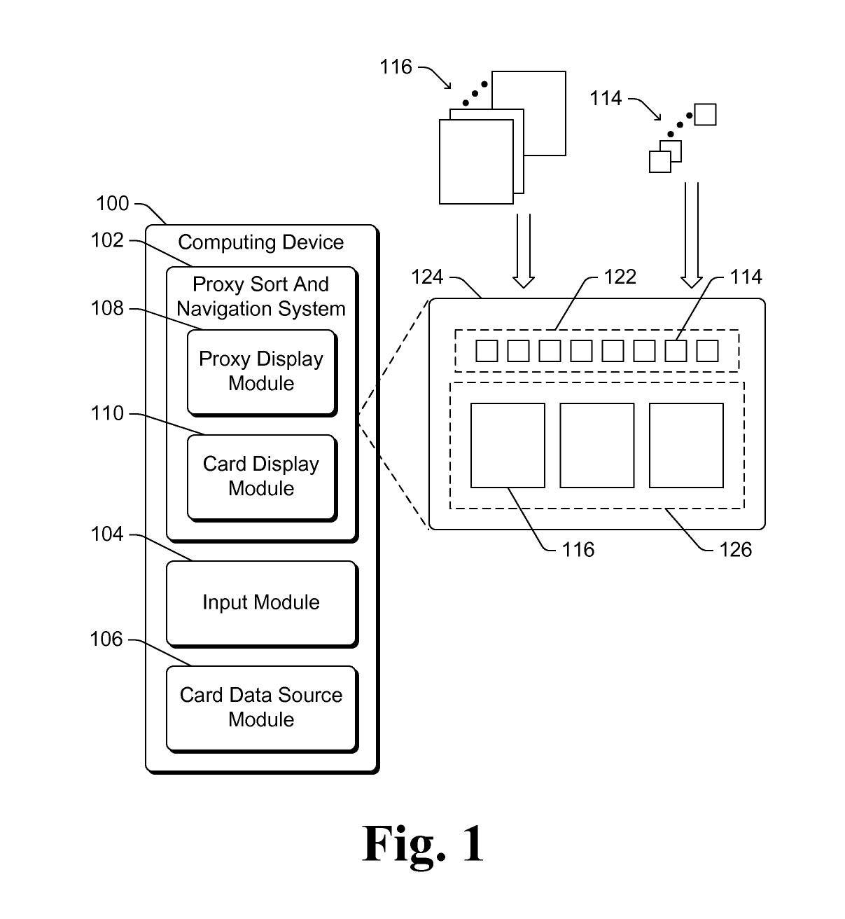

FIG. 1 is a block diagram illustrating an example computing device 100 implementing the proxy for sorting and navigating cards in accordance with one or more embodiments. The computing device 100 can be a variety of different types of devices, such as a physical device or a virtual device. For example, the computing device 100 can be a physical device such as a desktop computer, a server computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth. The computing device 100 can also be a virtual device, such as a virtual machine running on a physical device. A virtual machine can be run on any of a variety of different types of physical devices (e.g., any of the various types listed above). Thus, the computing device 100 may range from a full resource device with substantial memory and processor resources (e.g., personal computers, game consoles) to a low-resource device with limited memory and/or processing resources (e.g., traditional set-top boxes, hand-held game consoles).

The computing device 100 includes a proxy sort and navigation system 102, an input module 104, and a card data source module 106. The input module 104 receives user inputs from a user of the computing device 100. User inputs can be provided in a variety of different manners, such as by pressing one or more keys of a keypad or keyboard of the device 102, pressing one or more keys of a controller (e.g., remote control device, mouse, trackpad, etc.) of the device 102, pressing a particular portion of a touchpad or touchscreen of the device 102, pressing one or more buttons of a controller, making a particular gesture on a touchpad or touchscreen of the device 102, and/or making a particular gesture on a controller (e.g., remote control device, mouse, trackpad, etc.) of the device 102. User inputs can also be provided in other manners, such as via audible inputs to a microphone, via motions of hands or other body parts observed by an image capture device, and so forth.

The proxy sort and navigation system 102 includes a proxy display module 108 and a card display module 110. The proxy display module 106 manages display of a set of proxies 114 in a display area 122 of a user interface 124 of the computing device 100, and the card display module 110 manages display of a set of corresponding cards 116 in a display area 126 of the user interface 124. Each of the display areas 122 and 126 can also be referred to as a view portal. The user interface 124 is displayed by a display device that can be implemented as part of the computing device 100, or alternatively as a device separate from the computing device 100 that receives signals from the computing device 100.

The card display module 110 manages display of one or more cards 116 in the display area 126. A card, which may also be referred to as a widget, is a collection or grouping of data or content to be displayed. The data or content is oftentimes displayed within a boundary or container to facilitate a user distinguishing different collections of data or content from one another, although the boundary or container can alternatively be hidden (not displayed). The data or content can take different forms, such as a static image that is displayed, a collection of data or content that can change over time, and so forth. Although a set of multiple cards can be managed by the proxy sort and navigation system 102, oftentimes only a subset of those multiple cards is displayed at any one time. Only a subset of the multiple cards may be displayed at any given time for various reasons, such as because the size of the cards as displayed in the user interface is too big to display all the cards concurrently.

The card data source module 106 manages or otherwise obtains the data displayed as the set of cards. The data can be maintained locally on computing device 100, and/or obtained from another device or service (e.g., accessed via any one or more of a variety of data networks such as the Internet, a local area network (LAN), and so forth).

The proxy display module 108 manages display of one or more proxies 114 in the display area 122. Each proxy 114 corresponds to or represents a card in the set of multiple cards 116. In one or more embodiments all of the proxies corresponding to the set of multiple cards are displayed in the display area 122 even though not all of those cards may be displayed in the display area 126. For example, in the example of FIG. 1, three cards 116 are displayed in the display area 126, and eight proxies 114 are displayed in the display area 122.

The set of proxies 114 and the set of corresponding cards 116 are each arranged according to a particular ordering. Each proxy 114 is in a same location relative to the other proxies in the set of proxies 114 as the corresponding card 116 is to the other cards in the set of cards 116. Similarly, each card 116 is in a same location relative to the other cards in the set of cards 116 as the corresponding proxy 114 is to the other proxies in the set of proxies 114. For example, for a particular proxy corresponding to a particular card, if the particular proxy is the third proxy from the left in the set of proxies (or third proxy from the beginning of or other reference point in the set of proxies), then the particular card is the third card from the left in the set of cards (or third card from the beginning of or other reference point in the set of cards), and the particular card may or may not be included in the subset of cards that is displayed.

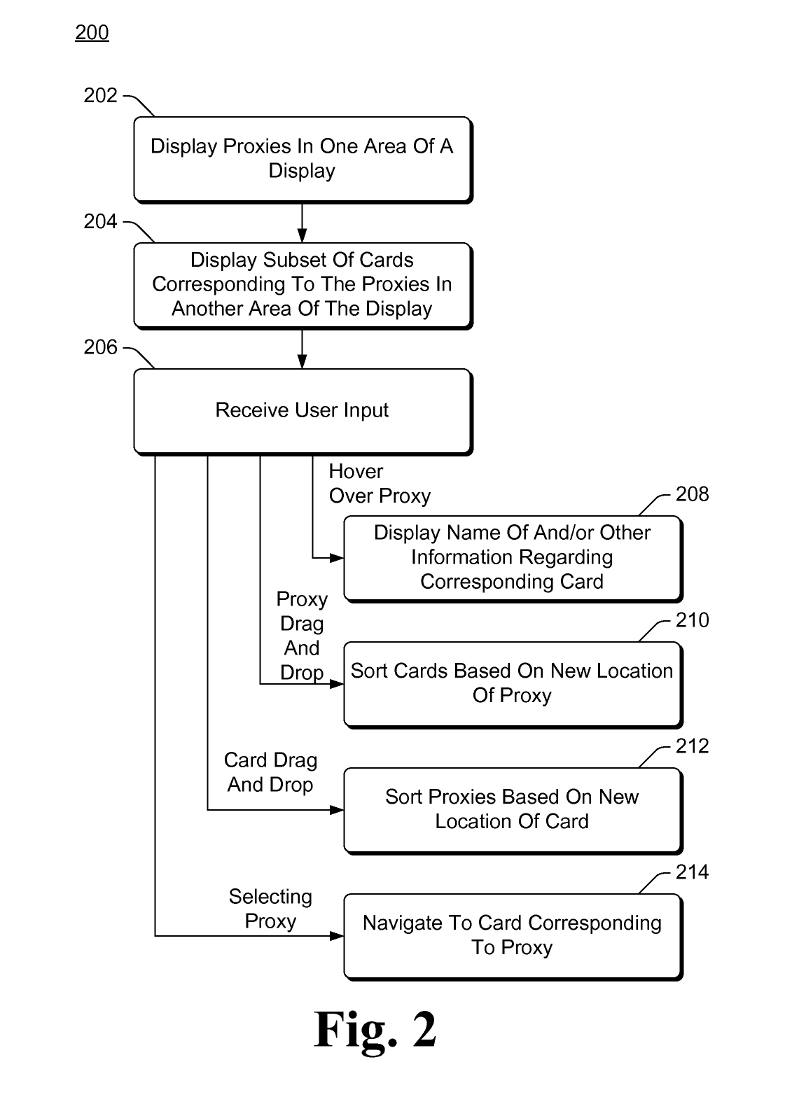

FIG. 2 is a flowchart illustrating an example process 200 for implementing the proxy for sorting and navigating cards in accordance with one or more embodiments. Process 200 is carried out by a proxy sort and navigation system 102, such as system 102 of FIG. 1, and can be implemented in software, firmware, hardware, or combinations thereof. Process 200 is shown as a set of acts and is not limited to the order shown for performing the operations of the various acts. Process 200 is an example process for implementing the proxy for sorting and navigating cards; additional discussions of implementing the proxy for sorting and navigating cards are included herein with reference to different figures.

In process 200, proxies are displayed in one area of a display (act 202). Each proxy corresponds to a card of a set of cards, and one proxy is displayed for each card in the set of cards as discussed above.

A subset of the set of cards is displayed in another area of the display (act 204). The size of the cards when displayed in combination with the quantity of cards in the set of cards prohibits all of the cards in the set of cards from being displayed concurrently in this other display area, so only a subset of the set of cards is displayed as discussed above.

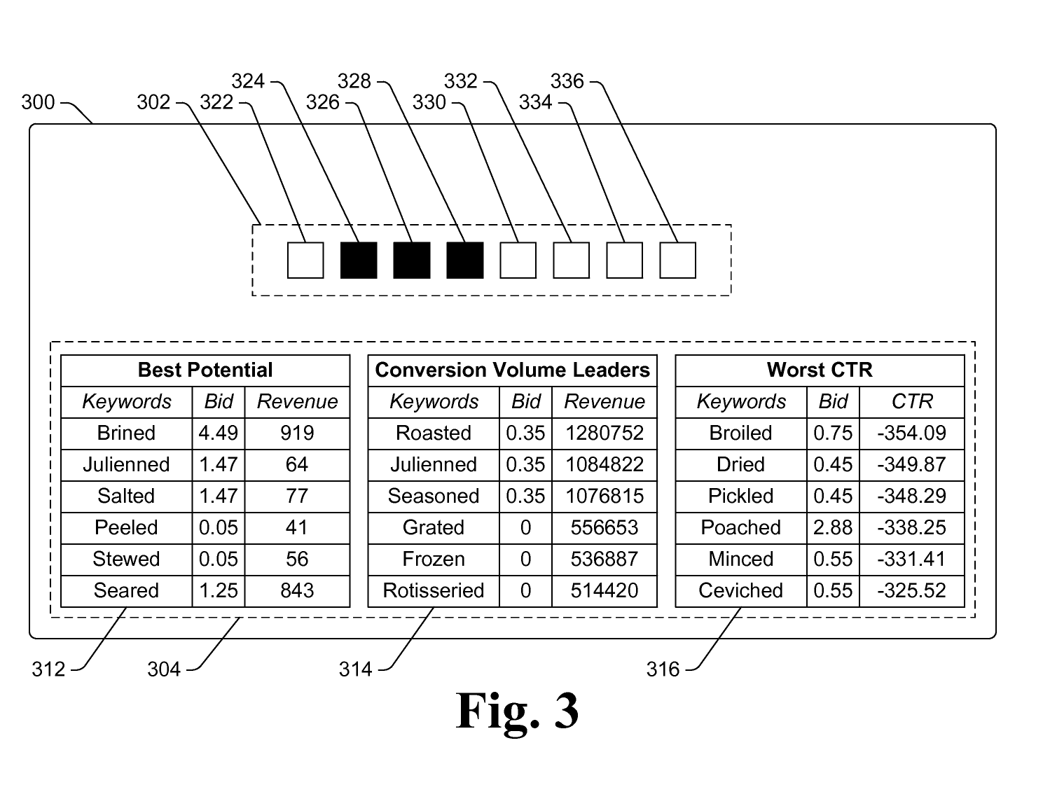

FIG. 3 illustrates an example user interface 300 displaying areas for proxies and cards in accordance with one or more embodiments. The user interface 300 includes a display area 302 in which proxies are displayed and a display area 304 in which cards are displayed. In the example of FIG. 3, three cards are illustrated as being displayed in the display area 304: card 312, card 314, and card 316. The cards 312-316 are part of a set of multiple cards, although only three cards of the set of multiple cards are displayed at any given time in the display area 304. Although three cards are illustrated in the display area 304, it should be noted that any number of cards can be displayed in the display area 304.

The cards 312-316 can display various data. In the illustrated example, the cards 312-316 display various data regarding advertising revenue and marketing. For example, the card 312 displays information regarding the perceived potential for revenue for particular keywords in advertising, the card 314 displays information regarding the volume of advertisements with particular keywords from which revenue was received, and the card 316 displays information regarding the click through rate (CTR) for particular keywords.

Also in the example of FIG. 3, eight proxies are illustrated as being displayed in the display area 302: proxy 322, proxy 324, proxy 326, proxy 328, proxy 330, proxy 332, proxy 334, and proxy 336. Each of the proxies 322-336 corresponds to one of the cards in the set of cards. In one or more embodiments, the proxy corresponding to a card being displayed in the display area 304 is displayed in a manner to indicate that the corresponding card is being displayed, such as displaying the proxy as filled in (e.g., black). The proxies corresponding to the three displayed cards 312, 314, and 316 are illustrated as filled in—the proxies corresponding to cards that are not displayed are illustrated as blank (not filled in). Thus, the proxies 324, 326, and 328 correspond to the cards 312, 314, and 316. Alternatively, the proxies corresponding to cards being displayed in the display area 304 can be distinguished from the proxies corresponding to cards not being displayed in the display area 304 in other manners, such as using different patterns, using different colors, using different borders around the proxies, using different sizes for the proxies, and so forth.

The proxies in the display area 302 are displayed in a particular order so that the locations of each of the proxies in the display area 302 relative to one another is the same as the locations of each of the cards in the display area 304 relative to one another. For example, the proxies in the display area 302 in order from left to right include the proxies 324, 326, and 328, and the cards in the display area 304 in order from left to right are cards 312, 314, and 316. The proxy 324 corresponds to the card 312, the proxy 326 corresponds to the card 314, and the proxy 328 corresponds to the card 316. The proxies in the display area 302 thus provide an indication of how many cards are in the set of cards, as well as the order of the cards.

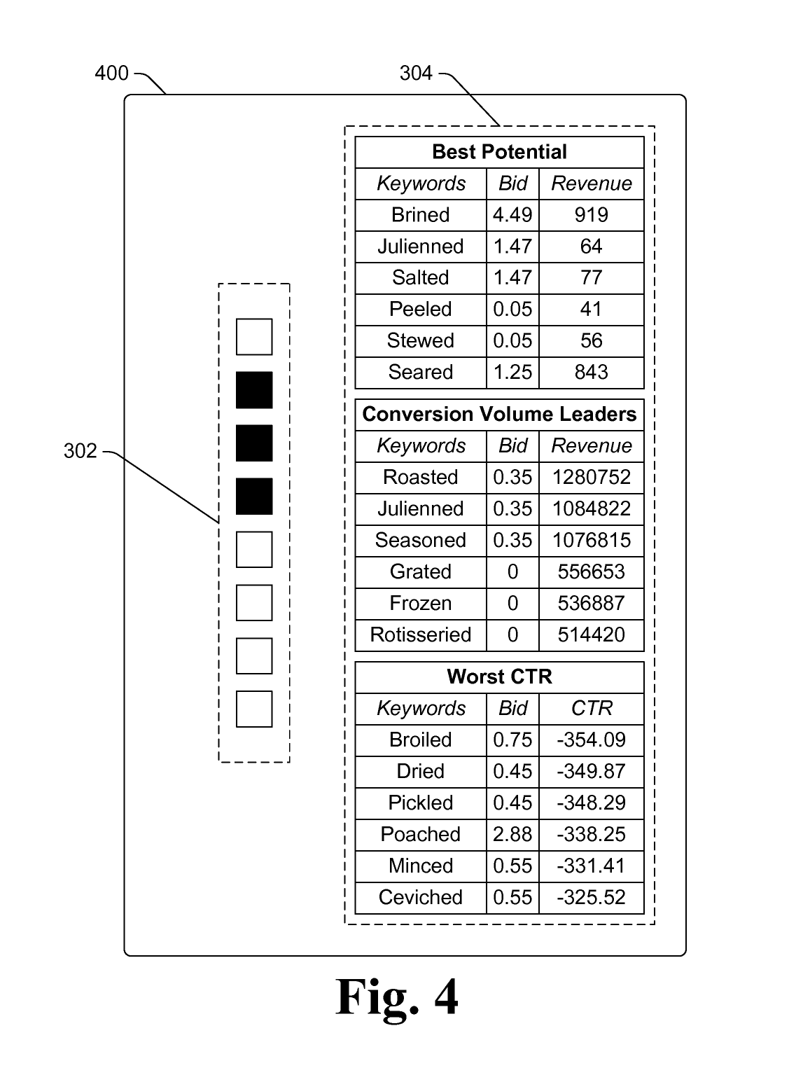

FIG. 4 illustrates a user interface 400 including display areas for proxies and cards in accordance with one or more embodiments. The user interface 400 is similar to the user interface 300 of FIG. 3, except that the set of proxies and cards are arranged vertically in the user interface 400 rather than horizontally as in the user interface 300. The user interface 400 includes a display area 302 in which proxies are displayed and a display area 304 in which cards are displayed. In the example of FIG. 4, three cards are illustrated as being displayed in the display area 304 analogous to FIG. 3, although the cards are displayed above and below each other (e.g., displayed vertically) rather than to the left and right of each other (e.g., displayed horizontally). The three displayed cards are part of a set of multiple cards as discussed above. Eight proxies are displayed in the display area 302 in the example of FIG. 4 analogous to FIG. 3, although the proxies are displayed above and below each other (e.g., displayed vertically) rather than to the left and right of each other (e.g., displayed horizontally). The proxies in the display area 302 and the cards in the display area 304 are displayed in a particular order so that the locations of each of the proxies in the display area 302 relative to one another is the same as the locations of each of the cards in display area 304 relative to one another analogous to the discussion above regarding FIG. 3, although the ordering is top to bottom (or bottom to top) in FIG. 4 rather than left to right (or right to left) as in FIG. 3.

Returning to FIG. 2, user input is received (act 206). The user input can be provided in various different manners as discussed above. Different types of user input can be received, such as a hovering over a proxy, dragging and dropping a proxy, dragging and dropping a card, and selecting (e.g., double clicking on) a proxy. Different actions are taken based on the type of user input, as discussed in more detail below. The process 200 proceeds based on the type of user input received in act 206.

In response to the user input being a hovering over a proxy, the name and/or other information regarding the card corresponding to the proxy being hovered over is displayed (act 208). Various information regarding the card corresponding to the proxy being hovered over can be displayed, such as a text description of the card, a reduced size image of the card, and so forth. Thus, a user can readily view the name and/or other information of the card corresponding to a proxy by hovering over the proxy, even though the card is not currently one of the subset of cards being displayed. Additionally or alternatively, various information can be presented in manners other than being displayed in response to a user input being a hovering over a proxy, such as playing back the text description of the card audibly.

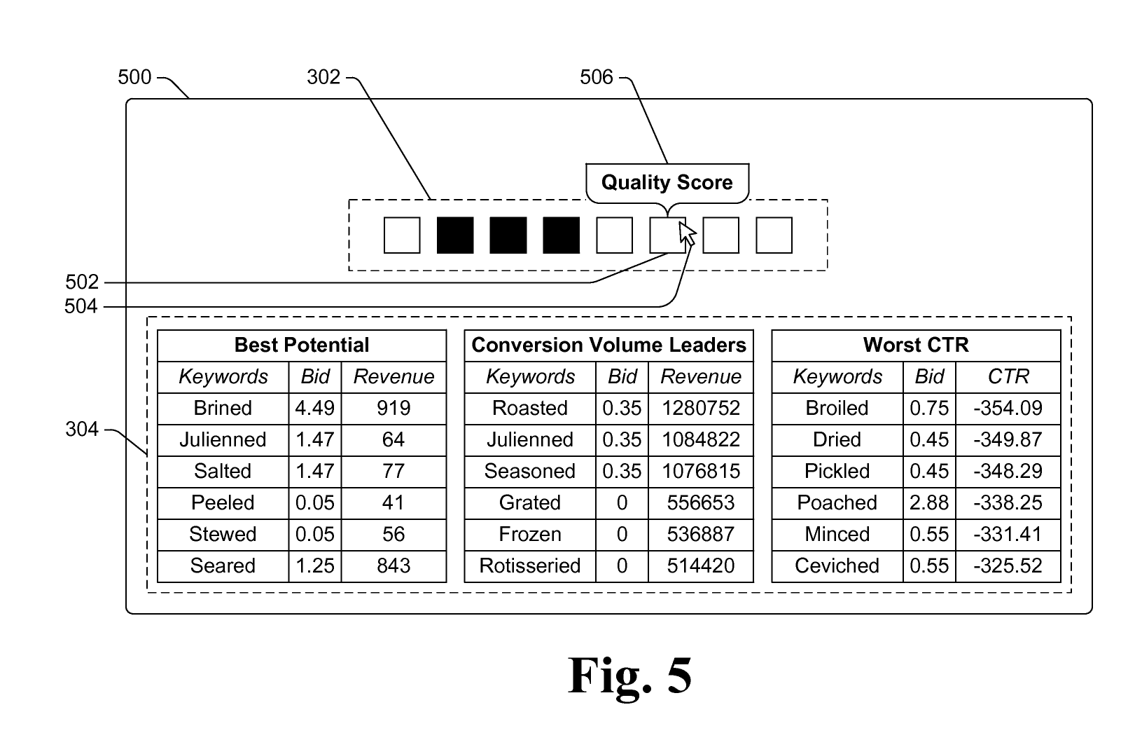

FIG. 5 illustrates an example user interface 500 displaying information regarding a card corresponding to a proxy being hovered over in accordance with one or more embodiments. The user interface 500 is similar to user interface 300 of FIG. 3, and includes a display area 302 in which proxies are displayed and a display area 304 in which cards are displayed. A user input hovering over the proxy 502 is illustrated as a pointer 504 hovering over the proxy 502. A user input hovering over a proxy refers to a pointer or other object being situated over the proxy and being stationary (not moving or moving less than a threshold distance) for at least a threshold amount of time. Although illustrated as an arrow, the pointer 504 can take any of a variety of different forms (e.g., an illustration of a hand, finger, pen, and so forth). Furthermore, although illustrated as a pointer in FIG. 5, the user input hovering over a proxy as discussed herein can alternatively refer to a finger of a user or another object (e.g., a stylus) being positioned over the surface of a display device displaying the proxy and being stationary (not moving or moving less than a threshold distance) for at least a threshold amount of time.

In response to the pointer 504 hovering over the proxy 502, a name 506 of the card corresponding to the proxy 502 is displayed. In the illustrated example, the name 506 of the card corresponding to the proxy 502 is “Quality Score”. The user input can be hovering over any of the proxies in the display area 302, including proxies corresponding to cards in the subset of cards currently displayed in the display area 304, and proxies corresponding to cards not currently displayed in the display area 304 (hidden cards).

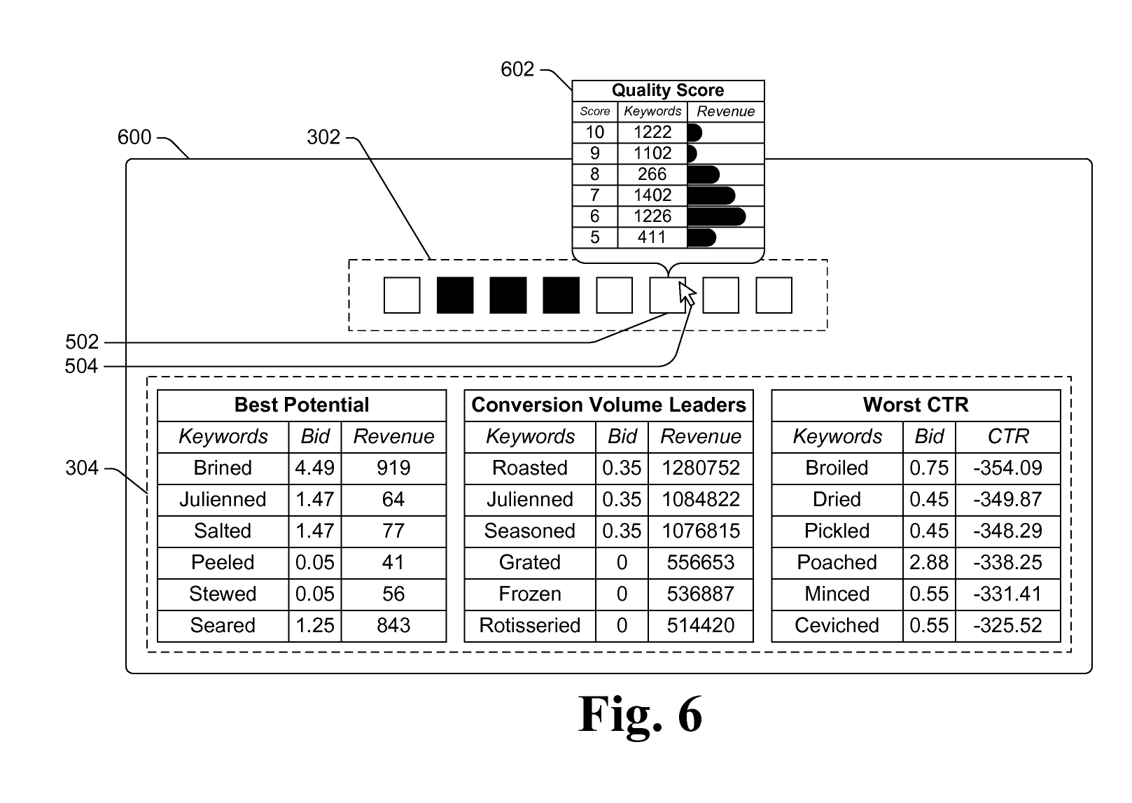

FIG. 6 illustrates an example user interface 600 displaying information regarding a card corresponding to a proxy being hovered over in accordance with one or more embodiments. The user interface 600 is similar to user interface 500 of FIG. 5, including the display areas 302 and 304, the proxy 502, and the pointer 504. The user interface 600 is analogous to the user interface 500 of FIG. 5, except that if the user input is a hovering over a proxy, then information 602 is displayed as illustrated in FIG. 6 rather than just the name of the card corresponding to the proxy 502 as illustrated in FIG. 5. In the illustrated example of FIG. 6, the information 602 is a reduced-size image of the card corresponding to the proxy 502.

Returning to FIG. 2, in response to the user input being dragging and dropping a proxy, the cards are sorted based on the new location of the proxy (act 210). As part of the dragging and dropping of a proxy, the order of the proxies is changed, with the dragged and dropped proxy being at a new location in the order relative to the other proxies in the set of proxies. The cards being sorted refers to changing the location of the card corresponding to the dragged and dropped proxy so that the location of the card is the same relative to the other cards in the set of cards as the location of the dragged and dropped proxy is to the other proxies in the set of proxies. For example, if a particular proxy is dragged and dropped from a location that is second in the order of the proxies to a location that is fifth in the order of the proxies, then the order of the cards is changed so that the card corresponding to that dragged and dropped proxy is fifth in the order of the set of cards rather than second. Thus, the user can readily change the order of the cards in the set of cards by dragging and dropping one or more proxies to new locations in the set of proxies, which can result in the order of the subset of cards being displayed changing as well as which cards are displayed as the subset of cards changing.

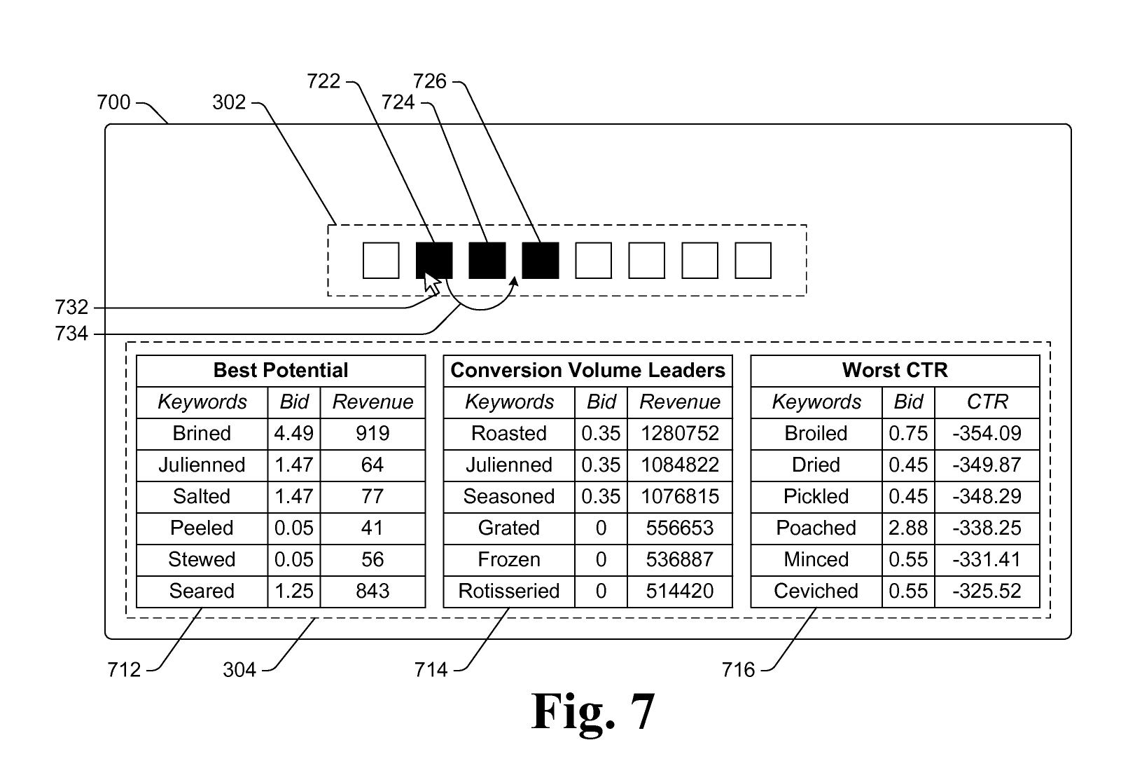

FIG. 7 illustrates an example user interface 700 displaying a proxy that is dragged and dropped to a new location in accordance with one or more embodiments. The user interface 700 is similar to the user interface 300 of FIG. 3, and includes the display area 302 in which proxies are displayed and the display area 304 in which cards are displayed. Cards 712, 714, and 716 correspond to proxies 722, 724, and 726, respectively. A user input dragging and dropping the proxy 722 to a new location is illustrated by a pointer 732 being used to select the proxy 722 (e.g., by pressing and holding a left button of a mouse or track pad while the pointer 732 is over the proxy 722, by touching a touch screen over the proxy 722, etc.) and an arrow 734 illustrating the location to which the proxy is dragged. As illustrated, the proxy 722 is dragged to and dropped at a location between the proxies 724 and 726.

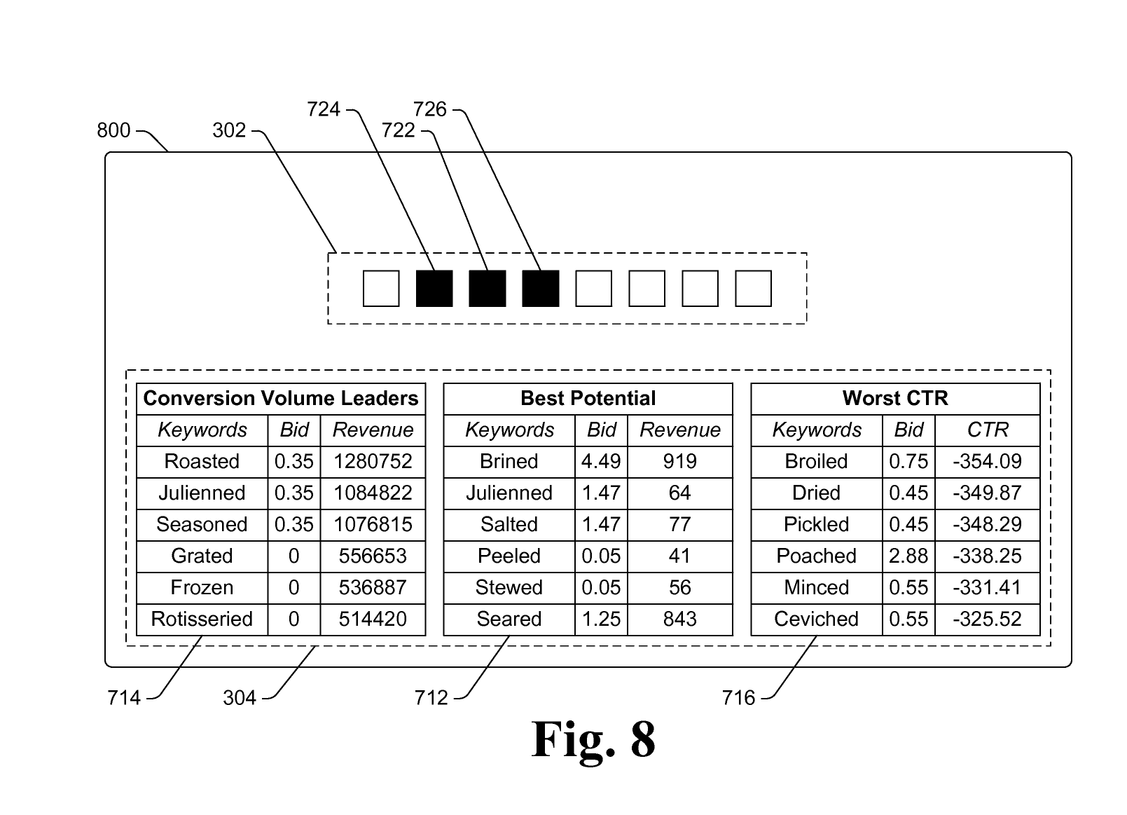

FIG. 8 illustrates an example user interface 800 displaying a proxy that has been dragged and dropped to a new location in accordance with one or more embodiments. The user interface 800 is similar to the user interface 700 of FIG. 7, and illustrates the display of proxies in the display area 302 and cards in the display area 304 after the proxy 722 has been dragged and dropped to the location between the proxies 724 and 726. The order of the proxies in the display area 302 has been changed after the dragging and dropping of the proxy 722, resulting in the proxy 722 being in a location between the proxies 724 and 726. The cards are also sorted, resulting in the order of the set of cards being changed so that the location of the card corresponding to the proxy 722 is the same relative to the other cards in the set of cards as the location of the dragged and dropped proxy is to the other proxies in the set of proxies. Accordingly, after sorting the card 712 (which corresponds to the proxy 722) is in a location between the card 714 (which corresponds to the proxy 724) and the card 716 (which corresponds to the proxy 726).

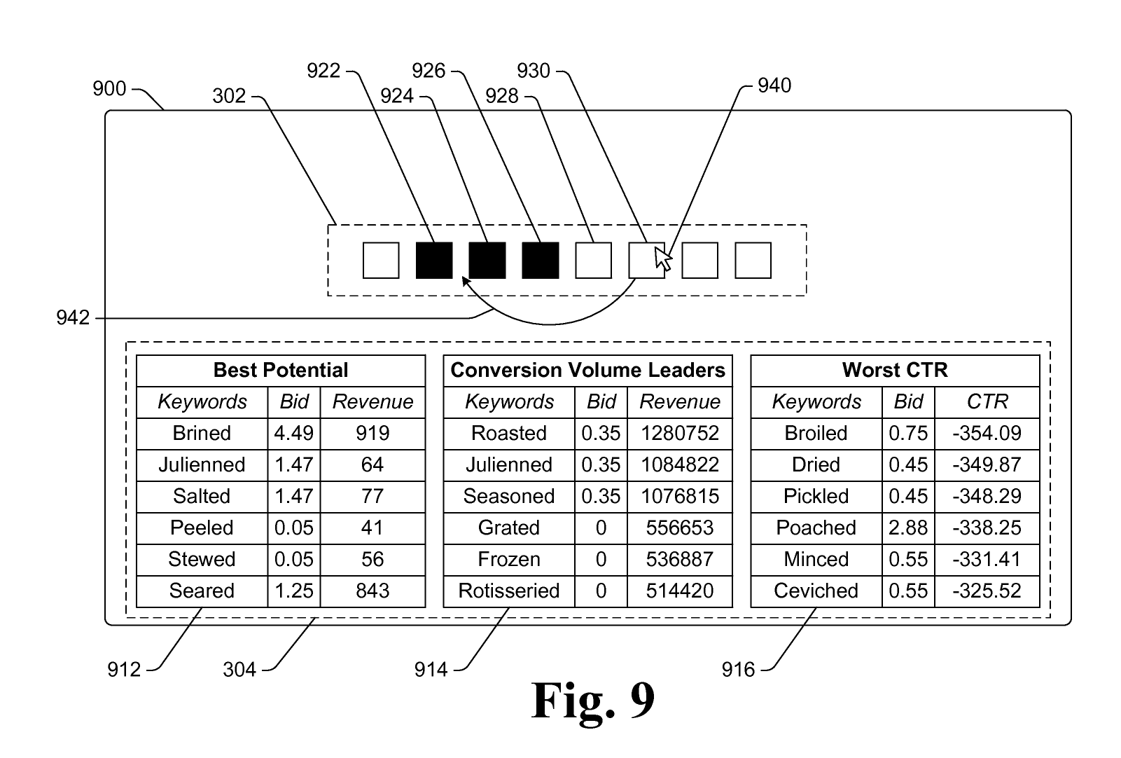

FIG. 9 illustrates an example user interface 900 displaying a proxy that is dragged and dropped to a new location in accordance with one or more embodiments. The user interface 900 is similar to the user interface 300 of FIG. 3, and includes the display area 302 in which proxies are displayed and the display area 304 in which cards are displayed. Cards 912, 914, and 916 correspond to proxies 922, 924, and 926, respectively. Proxies 928 and 930 correspond to cards not included in the subset of cards being displayed in the display area 304. A user input dragging and dropping the proxy 930 to a new location is illustrated by a pointer 940 being used to select the proxy 930 (e.g., by pressing and holding a left button of a mouse or track pad while the pointer 940 is over the proxy 930, by touching a touch screen over the proxy 930, etc.) and an arrow 942 illustrating the location to which the proxy is dragged. As illustrated, the proxy 930 is dragged to and dropped at a location between the proxies 922 and 924.

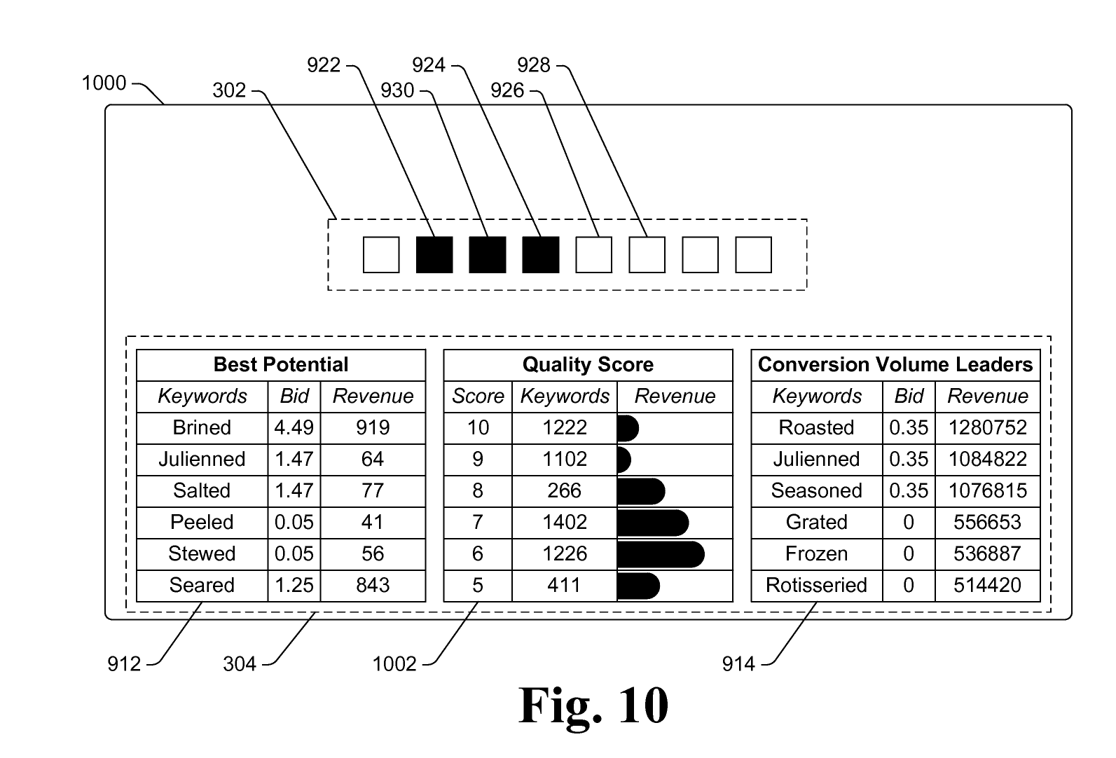

FIG. 10 illustrates an example user interface 1000 displaying a proxy that has been dragged and dropped to a new location in accordance with one or more embodiments. The user interface 1000 is similar to the user interface 900 of FIG. 9, and illustrates the display of proxies in the display area 302 and cards in the display area 304 after the proxy 930 has been dragged and dropped to the location between the proxies 922 and 924. The order of the proxies in the display area 302 has been changed after the dragging and dropping of the proxy 930, resulting in the proxy 930 being in a location between the proxies 922 and 924. The locations of proxies to the right of the proxy 924 (e.g., the proxies 926 and 928) have been shifted to the right. The cards are also sorted, resulting in the order of the set of cards being changed so that the location of the card corresponding to the proxy 930 is the same relative to the other cards in the set of cards as the location of the dragged and dropped proxy is to the other proxies in the set of proxies. Accordingly, after sorting the card 1002 (which corresponds to the proxy 930) is in a location between the card 912 (which corresponds to the proxy 922) and the card 914 (which corresponds to the proxy 924).

Returning to FIG. 2, in response to the user input being dragging and dropping a card, the proxies are sorted based on the new location of the card (act 212). As part of the dragging and dropping of a card, the order of the cards is changed, with the dragged and dropped card being at a new location in the order relative to the other cards in the set of cards. The proxies being sorted refers to changing the location of the proxy corresponding to the dragged and dropped card so that the location of the proxy is the same relative to the other proxies in the set of proxies as the location of the dragged and dropped card is to the other cards in the set of cards. For example, if a particular card is dragged and dropped from a location that is second in the order of the cards to a location that is third in the order of the cards, then the order of the proxies is changed so that the proxy corresponding to that dragged and dropped card is third in the order of the set of proxies rather than second. Thus, the user can readily change the order of the proxies in the set of proxies by dragging and dropping one or more cards to new locations in the set of cards.

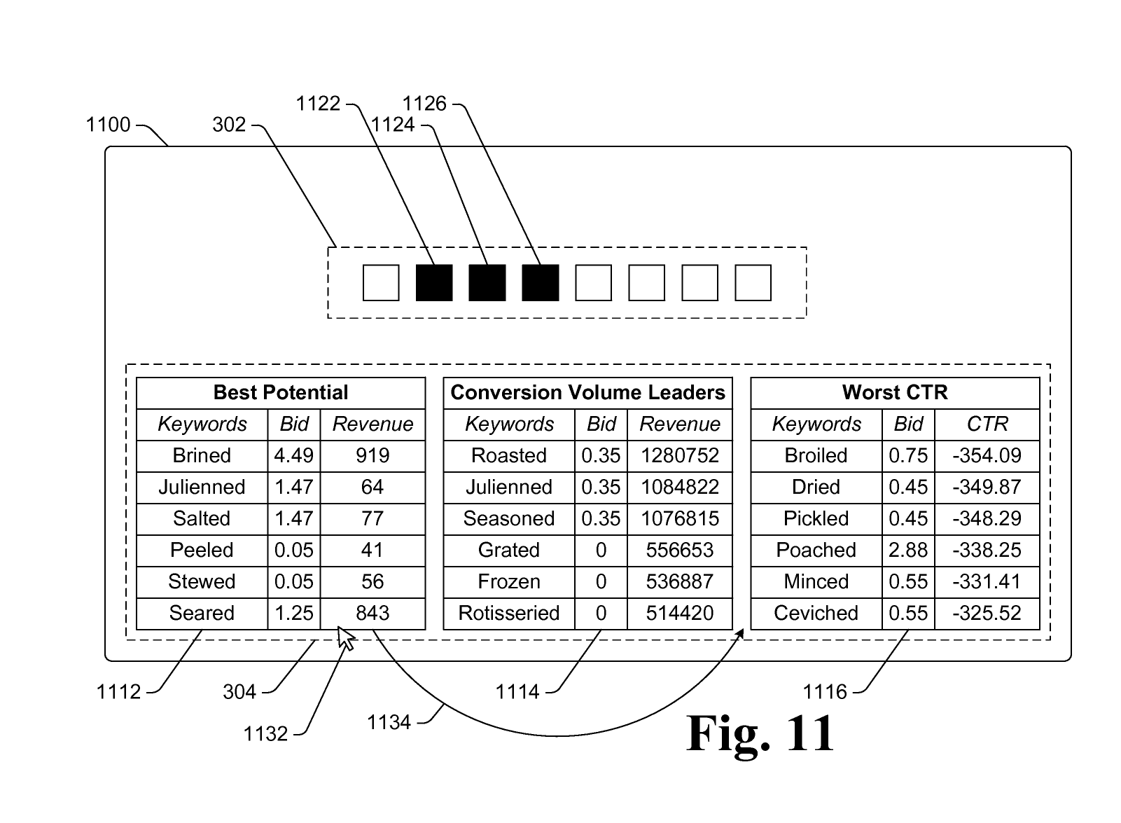

FIG. 11 illustrates an example user interface 1100 displaying a card that is dragged and dropped to a new location in accordance with one or more embodiments. The user interface 1100 is similar to the user interface 300 of FIG. 3, and includes the display area 302 in which proxies are displayed and the display area 304 in which cards are displayed. Cards 1112, 1114, and 1116 correspond to proxies 1122, 1124, and 1126, respectively. A user input dragging and dropping the card 1112 to a new location is illustrated by a pointer 1132 being used to select the card 1112 (e.g., by pressing and holding a left button of a mouse or track pad while the pointer 1132 is over the card 1112, by touching a touch screen over the card 1112, etc.) and an arrow 1134 illustrating the location to which the card is dragged. As illustrated, the card 1112 is dragged to and dropped at a location between the cards 1114 and 1116.

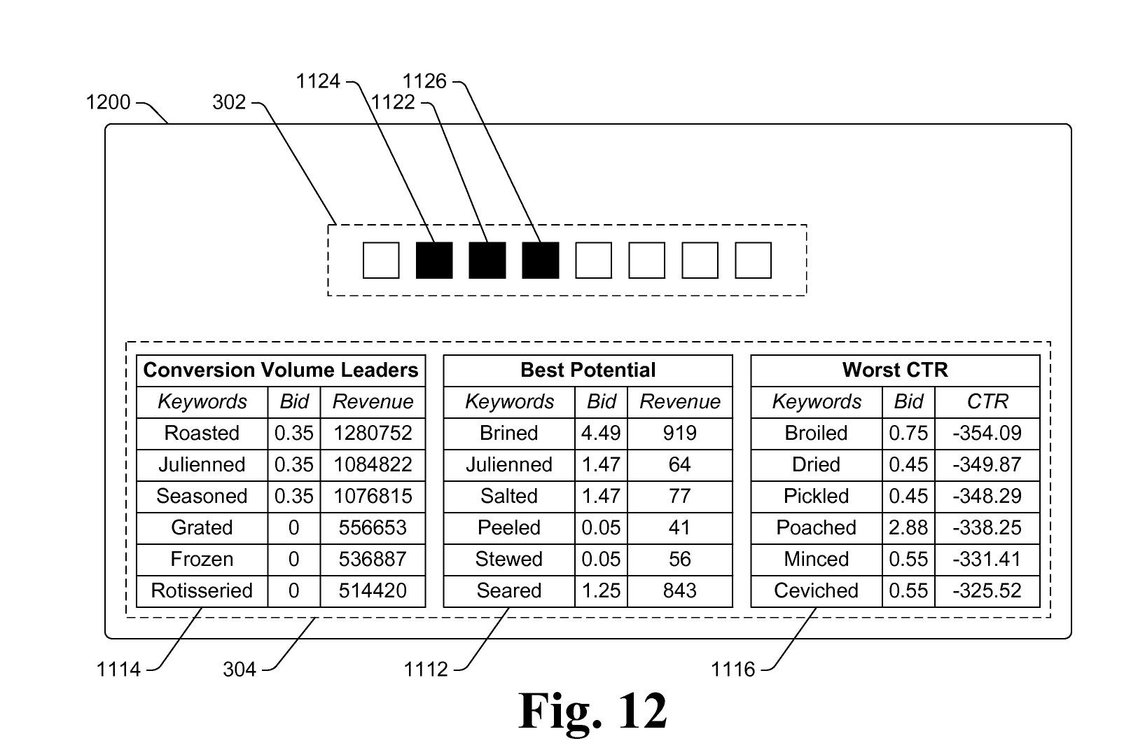

FIG. 12 illustrates an example user interface 1200 displaying a card that has been dragged and dropped to a new location in accordance with one or more embodiments. The user interface 1200 is similar to the user interface 1100 of FIG. 11, and illustrates the display of proxies in the display area 302 and cards in the display area 304 after the card 1112 has been dragged and dropped to the location between the cards 1114 and 1116. The order of the cards in the display area 304 has been changed after the dragging and dropping of the card 1112, resulting in the card 1112 being in a location between the cards 1114 and 1116. The proxies are also sorted, resulting in the order of the set of proxies being changed so that the location of the proxy corresponding to the card 1112 is the same relative to the other proxies in the set of proxies as the location of the dragged and dropped card is to the other cards in the set of cards. Accordingly, after sorting the proxy 1122 (which corresponds to the card 1112) is in a location between the proxy 1124 (which corresponds to the card 1114) and the proxy 1126 (which corresponds to the card 1116).

Returning to FIG. 2, in response to the user input being selecting a proxy, the card corresponding to the selected proxy is navigated to (act 214). The selection can be made in a variety of different manners, such as by a user double clicking on the proxy (e.g., a user double clicking a left button of a mouse or track pad while a pointer is over the proxy), by a user tapping a touch screen once (or twice within a threshold amount of time) over the proxy, and so forth. Navigating to the card corresponding to the selected proxy refers to changing the subset of cards that are displayed so that the card corresponding to the selected proxy is displayed. The selection of a proxy in act 214 is a different than the selection of a proxy for dragging and dropping—proxies can be selected in different manners via different user inputs, and the manner in which a proxy is selected indicates the type of user input. For example, a proxy may be selected for dragging and dropping by a user input pressing and holding a left button of a mouse or track pad while a pointer is over the proxy, and the proxy may be selected for navigation to by a user input a user double clicking on the proxy.

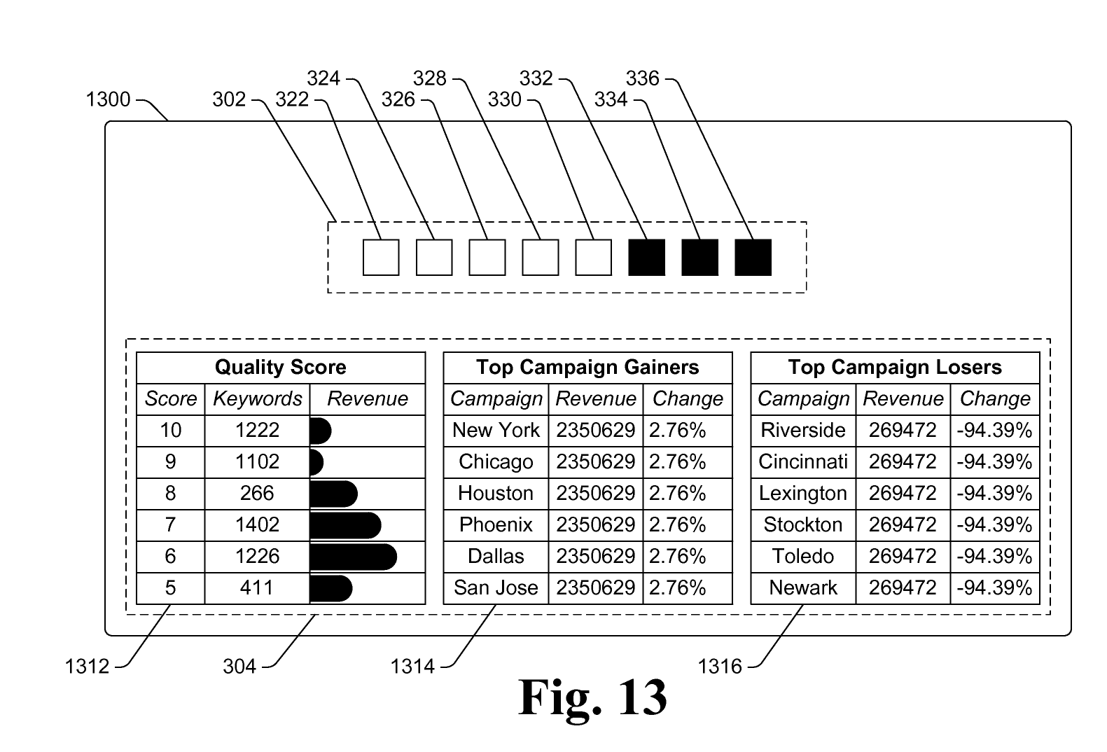

FIG. 13 illustrates an example user interface 1300 displaying a card that has been navigated to in accordance with one or more embodiments. The user interface 1300 is similar to the user interface 300 of FIG. 3, and includes the display area 304 in which cards 1312, 1314, and 1316 are displayed, and the display area 302 in which proxies 322, 324, 326, 328, 330, 332, 334, and 336 are displayed. The user interface 1300 illustrates a result of the proxy 332 having been selected. In response to selection of the proxy 332, the subset of cards displayed in the display area 304 includes the card 1312 (which corresponds to the proxy 332). Additional cards are also displayed in the display area in response to selection of the proxy 332: the card 1314 (which corresponds to the proxy 334) and the card 1316 (which corresponds to the proxy 336). The proxies 332, 334, and 336 corresponding to the three displayed cards 1312, 1314, and 1316, respectively, are illustrated as filled in—the proxies corresponding to cards that are not displayed are illustrated as blank (not filled in). As illustrated in FIG. 13, the cards that are displayed in the display area 304 include cards that are absent from the subset of cards displayed in the display area 304 of FIG. 3.

In the illustrated example of FIG. 13, the card 1312 corresponding to the proxy 332 is displayed as the left-most card in the display area 304. Alternatively, the card 1312 can be displayed in different parts of the display area 304, and different subsets of cards can be displayed in the display area 304. For example, the card 1312 can be displayed in the middle of the display area 304, and the subset of cards displayed in the display area 304 can include the card 1312, the card 1314 displayed to the right of the card 1312, and a card corresponding to the proxy 330 displayed to the left of the card 1312.

Returning to FIG. 1, the proxy display module 108 maintains a record of the proxies in the set of proxies 114, and the card display module 108 maintains a record of the cards in the set of cards 116. In response to a user input changing a location of a proxy in the set of proxies 114, a notification is provided (e.g., by the proxy display module 108) to the card display module 110 of the change in location. In response to the notification, the card display module 110 sorts the set of cards 116 so that the location of the card corresponding to the proxy whose location was changed is also changed, resulting in the location of the card corresponding to the proxy whose location was changed being changed to a location that is the same relative to the other cards in the set of cards 116 as the location of the proxy whose location was changed is to the other proxies in the set of proxies. The notification can take various forms, such as firing an event for which the card display module 110 listens, invoking an application programming interface (API) method exposed by the card display module 110, and so forth.

Similarly, in response to a user input changing a location of a card in the set of cards 116, a notification is provided (e.g., by the card display module 110) to the proxy display module 108 of the change in location. In response to the notification, the proxy display module 108 sorts the set of proxies 114 so that the location of the proxy corresponding to the card whose location was changed is also changed, resulting in the location of the proxy corresponding to the card whose location was changed being changed to a location that is the same relative to the other proxies in the set of proxies 114 as the location of the card whose location was changed is to the other cards in the set of cards 116. The notification can take various forms, such as firing an event for which the proxy display module 108 listens, invoking an application programming interface (API) method exposed by the proxy display module 108, and so forth.

The record of the set of proxies 114 maintained by the proxy display module 108 includes various information for each proxy in the set of proxies 114. This information can include a name or other identifier of the proxy, and optionally additional information to be displayed when the proxy is hovered over. Thus, in response to a user input of hovering over the proxy, the name or other information to display for the proxy can be readily determined by the proxy display module 108, even if the location of the proxy in the order of proxies has been changed. The record of the set of cards maintained by the card display module 110 can include a name or other identifier of the card, and the information displayed for each card in the set of cards. This information includes information that can be displayed as part of the card or an indication (e.g., a uniform resource identifier (URI)) of where information to be displayed as part of the card can be obtained.

The information maintained by the proxy display module 108 can also optionally include information identifying an icon or image to display as the proxy. Different proxies in the set of proxies 114 can have the same icon or image displayed (e.g., the same black shape if the corresponding card is displayed in the display area 126, and the same white shape if the corresponding card is not displayed in the display area 126), or alternatively different icons or images. The icon or image to be displayed is included in the information maintained by the module 108, and can take different forms. For example, the icon or image may be a small image (approximately the same size as the proxies corresponding to the other cards) of the corresponding card.

The information maintained by the card display module 110 for a card can also optionally include one or more controls allowing a user to interact with the card. These controls can be, for example, user-selectable buttons, user-selectable links, and so forth. Such controls can provide various functionality, such as allowing the user to change a value displayed as part of the card, allowing the user to identify additional information to display as part of the card, allowing the user to provide data or requests to other modules or devices, and so forth.

The records of the proxies and/or cards can be maintained in a variety of different manners. For example, the records can be document object models (DOMs) identifying the proxies and/or cards. Alternatively, various other data structures can be used as the records, such as arrays, trees, linked lists, and so forth.

The correspondence between cards and proxies can be identified in a variety of different manners. In one or more embodiments, for each card and its corresponding proxy, both the card and the corresponding proxy have the same name or other identifier. A card thus corresponds to a proxy if the card has the same name or other identifier as the proxy, and vice versa. Alternatively, the correspondence between cards and proxies can be identified in other manners, such as using names or identifiers from which a common name or identifier can be derived, using another record that maps the names or identifiers of proxies to corresponding cards, including in a card a URI or other identifier of the corresponding proxy, including in a proxy a URI or other identifier of the corresponding card, and so forth.

The display modules 108 and 110 can be implemented in a variety of different manners. In one or more embodiments, the modules 108 and 110 are each an instance of a view portal object that manages display of a display area. One instance manages the display of proxies in the display area 122, and the other instance manages the display of cards in the display area 126. Alternatively, two different objects can be used, one object managing display of the display area 122 and the other object managing the display of the display area 126. Alternatively, a single object can manage the display of multiple display areas.

In one or more embodiments, the display areas in which the proxies and/or cards are displayed are dynamic, which refers to the display areas being resizable during display of the proxies and/or cards. Various inputs can be received to indicate resizing of a display area, such as user selection of a menu item, user dragging and dropping a corner or edge of a boundary box surrounding the display area, commands received from other modules or devices to alter the size of the display area, and so forth. In response to an input to resize a display area, the size of the display area is changed as indicated, and sizes of the proxies and/or cards can optionally be changed as well. The amount of change in size of the proxies and/or cards can be proportional to the change in size of the display area. For example, if the pixel display area is reduced in size by 10%, then the size of the proxies can be reduced by 10%. By way of another example, if the length of the pixel display area is increased by 20%, then the width of the proxies can be increased by 20%.

A proxy and/or card can optionally have a lower threshold size below which it is not reduced and an upper threshold size above which it is not increased. In such situations, the changing of the size of the display area can be restricted to not being reduced to a size that would result in the proxies and/or cards dropping below the lower threshold size. The changing of the size of the display area can be restricted to not being increased to a size that would result in the proxies and/or cards increasing above the upper threshold size, or the proxies and/or cards may stop changing in size once the upper threshold size is reached.

Situations can also arise in which the size of a card display area is reduced such that it can no longer display the same number of cards as were displayed prior to the display area being reduced. In such situations, the number of cards included in the subset displayed in the display area can be reduced. For example, rather than displaying three cards in display area 126, only two cards may be displayed in display area 126.

The proxy sort and navigation system 102 can be implemented using any of a variety of different languages. In one or more embodiments, the system 102 can be implemented using JavaScript, using various methods such as jQuery to determine the new location where a card (or proxy) is to be placed and placing the card (or proxy) in that location. Alternatively, the system 102 can be implemented using various other languages, such as the Dart programming language and Google Web Toolkit.

In the discussions above, changing locations of proxies and/or cards is discussed. In one or more embodiments, the changes are abrupt and are made in the absence of any appearance of motion or animation. In other embodiments, the changes are made to simulate the appearance of cards or proxies moving through a set. For example, referring to FIGS. 3 and 11, in response to the proxy 332 being selected, the display area 304 is changed from displaying the subset of cards 312, 314, and 316 to displaying the subset of cards 1112, 1114, and 1116. The change in cards displayed in the display area 304 can be animated to provide an appearance that the cards are being scrolled or moved through rather than changing abruptly from displaying the cards 312-316 of FIG. 3 to displaying the cards 1112-1116 of FIG. 11.

The animation of changing cards can be performed in a variety of different manners. In one or more embodiments, the cards displayed and where those cards are displayed in the display area are changed a particular amount (e.g., a few pixels) at particular intervals (e.g., every 50 or 100 milliseconds) to provide an appearance to the user that the cards are moving across the display device. Alternatively, if the language being used to implement the proxy sort and navigation system 102 supports animation, such support can be invoked when changing the locations of cards to provide the appearance to the user that the cards are moving across the display device. The animation of changing proxies can be performed analogously in a variety of different manners.

In one or more embodiments, cards can be added to the set of cards and corresponding proxies can be added to the set of proxies. A user input requesting to add a card can be received in a variety of different manners, such as user selection of a menu item or button displayed on the user interface 124, user selection of an “add” icon or proxy in the display area 122 (e.g., an icon resembling the icons displayed as the set of proxies but with a “+” symbol displayed on the icon or displaying a name of “add” when the icon is hovered over), and so forth. In response to the user input requesting to add a card, various prompts can be displayed to the user to allow the user to identify the information to be included in the newly added card. The new card is added to the set of cards, and the corresponding proxy is added to the set of proxies. The new card is added to a location in the set of cards and the corresponding proxy is added to a location in the set of proxies so that the new card is in a same location relative to the other cards in the set of cards as the new proxy is to the other proxies in the set of proxies.

Additionally, in one or more embodiments cards can be deleted from the set of cards and corresponding proxies can be deleted from the set of proxies. A user input requesting to delete a card can be received in a variety of different manners, such as user selection of a menu item or button displayed on the user interface 124, a user input dragging and dropping the proxy corresponding to the card to be deleted in a particular area of the user interface (e.g., a trash can or recycle bin), and so forth. In response to the user input requesting to delete a card, the user specified card is deleted from the set of cards, and the corresponding proxy is deleted from the set of proxies.

The techniques discussed herein support a variety of different usage scenarios. For example, the user can hover over various different proxies to identify the name of a desired card (the names of each proxy and corresponding card being the same), and then double click on the proxy to have the desired card displayed. By way of another example, the user can readily sort the set of cards by dragging and dropping proxies—no separate configuration or sorting page or window need be opened and displayed to allow such sorting. By way of further example, the user can simply double click on or touch a proxy to have the corresponding card displayed—the user need not click on or otherwise select different buttons, menu options, and so forth to identify the card he or she desires to have displayed.

Although particular functionality is discussed herein with reference to particular modules, it should be noted that the functionality of individual modules discussed herein can be separated into multiple modules, and/or at least some functionality of multiple modules can be combined into a single module.

Various actions performed by various modules are discussed herein. A particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

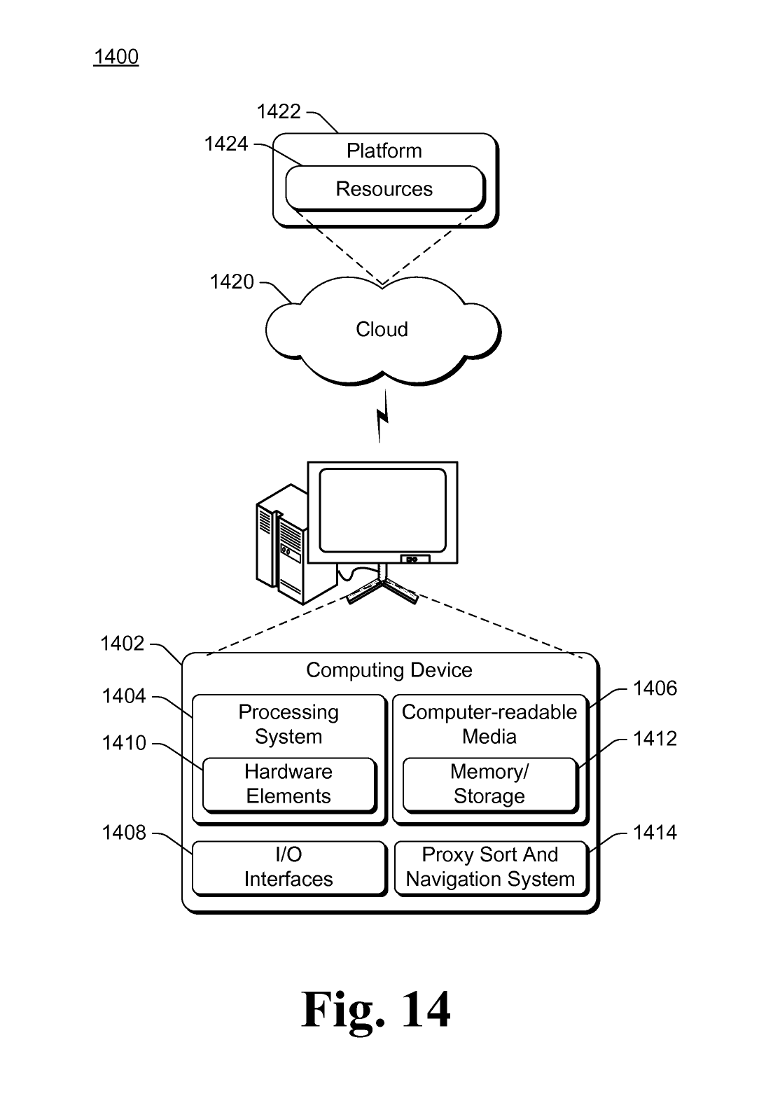

FIG. 14 illustrates an example system generally at 1400 that includes an example computing device 1402 that is representative of one or more computing systems and/or devices that may implement the various techniques described herein. This is illustrated through inclusion of the proxy sort and navigation system 1414, which may be configured to implement the proxy for sorting and navigating cards. Computing device 1402 may be, for example, a server of a service provider, a device associated with a client (e.g., a client device), an on-chip system, and/or any other suitable computing device or computing system.

The example computing device 1402 as illustrated includes a processing system 1404, one or more computer-readable media 1406, and one or more I/O interfaces 1408 that are communicatively coupled, one to another. Although not shown, computing device 1402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

Processing system 1404 is representative of functionality to perform one or more operations using hardware. Accordingly, processing system 1404 is illustrated as including hardware elements 1410 that may be configured as processors, functional blocks, and so forth. This may include implementation in hardware as an application specific integrated circuit or other logic device formed using one or more semiconductors. Hardware elements 1410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

Computer-readable storage media 1406 is illustrated as including memory/storage 1412. Memory/storage 1412 represents memory/storage capacity associated with one or more computer-readable media. Memory/storage component 1412 may include volatile media (such as random access memory (RAM)) and/or nonvolatile media (such as read only memory (ROM), Flash memory, optical disks, magnetic disks, and so forth). Memory/storage component 1412 may include fixed media (e.g., RAM, ROM, a fixed hard drive, and so on) as well as removable media (e.g., Flash memory, a removable hard drive, an optical disc, and so forth). Computer-readable media 1406 may be configured in a variety of other ways as further described below.

Input/output interface(s) 1408 are representative of functionality to allow a user to enter commands and information to computing device 1402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, computing device 1402 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by computing device 1402. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1410 and computer-readable media 1406 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1410. Computing device 1402 may be configured to implement particular instructions and/or functions corresponding to the software and/or hardware modules. Accordingly, implementation of a module that is executable by computing device 1402 as software may be achieved at least partially in hardware, e.g., through use of computer-readable storage media and/or hardware elements 1410 of processing system 1404. The instructions and/or functions may be executable/operable by one or more articles of manufacture (for example, one or more computing devices 1402 and/or processing systems 1404) to implement techniques, modules, and examples described herein.

The techniques described herein may be supported by various configurations of computing device 1402 and are not limited to the specific examples of the techniques described herein. This functionality may also be implemented all or in part through use of a distributed system, such as over a “cloud” 1420 via a platform 1422 as described below.

Cloud 1420 includes and/or is representative of a platform 1422 for resources 1424. Platform 1422 abstracts underlying functionality of hardware (e.g., servers) and software resources of cloud 1420. Resources 1424 may include applications and/or data that can be utilized while computer processing is executed on servers that are remote from computing device 1402. Resources 1424 can also include services provided over the Internet and/or through a subscriber network, such as a cellular or Wi-Fi network.

Platform 1422 may abstract resources and functions to connect computing device 1402 with other computing devices. Platform 1422 may also serve to abstract scaling of resources to provide a corresponding level of scale to encountered demand for resources 1424 that are implemented via platform 1422. Accordingly, in an interconnected device embodiment, implementation of functionality described herein may be distributed throughout system 1400. For example, the functionality may be implemented in part on computing device 1402 as well as via platform 1422 that abstracts the functionality of the cloud 1420.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
displaying, in a first display area of a user interface, a first subset of a set of cards in a particular order relative to one another;
displaying, in a second display area of the user interface, a set of proxies in a particular order relative to one another, each proxy corresponding to a card of the set of cards and the set of proxies including a proxy for each card in the set of cards;
receiving a user input to change a location of one of the proxies in the particular order in the second display area;
changing, in response to the user input, the particular order of the first subset of cards in the first display area based on the changed location of the one proxy; and
changing, in response to the user input, the particular order of the set of proxies displayed in the second display area.

2. A method as recited in claim 1, the user input comprising dragging and dropping the one proxy in the second display area.

3. A method as recited in claim 1, further comprising:
receiving an additional user input adding a new card to the set of cards; and
adding, in response to the additional user input, to the set of proxies a new proxy corresponding to the new card in a location in the particular order of the set of proxies so that the new proxy is in a same location relative to the other proxies of the set of proxies as the new card is relative to the other cards of the set of cards.

4. A method as recited in claim 1, further comprising:
detecting a hovering over one of the proxies in the first display area; and
displaying, in response to detecting the hovering over one of the proxies, a name of a card corresponding to the one proxy being hovered over.

5. A method as recited in claim 1, further comprising:
detecting a hovering over one of the proxies in the first display area; and
displaying, in response to detecting the hovering over one of the proxies, a reduced size image of a card corresponding to the one proxy being hovered over.

6. A method as recited in claim 1, further comprising:
receiving an additional user input selecting one proxy of the set of proxies corresponding to a particular one card of the set of cards; and
changing, in response to the additional user input, to displaying a second subset of the set of cards in the first display area, the second subset of cards including the particular one card.

7. A method as recited in claim 6, the additional user input selecting the one proxy comprising a double clicking on the one proxy.

8. A method as recited in claim 1, further comprising changing, in response to the user input, to displaying a second subset of the set of cards in the first display area, the second subset of cards including a card of the set of cards corresponding to the one of the proxies as well as one or more other cards absent from the first subset of cards.

9. A method as recited in claim 1, each of the first display area and the second display area being resizable.

10. A method comprising:
displaying, in a first display area of a user interface, a subset of cards of a set of cards in a particular order relative to one another;
displaying, in a second display area of the user interface, a set of proxies in a particular order relative to one another, each proxy corresponding to one of the set of cards and the set of proxies including a proxy for each card in the set of cards;
receiving a user input dragging and dropping one of the proxies in the set of proxies to a different location in the particular order in the second display area; and
sorting, in response to the user input, the cards in the first display area so that the card corresponding to the one proxy is in a same location relative to the other cards of the set of cards as the one proxy is relative to the other proxies of the set of proxies.

11. A method as recited in claim 10, further comprising:
detecting a hovering over one of the proxies in the first display area; and
displaying, in response to detecting the hovering over one of the proxies, a name of a card corresponding to the one proxy being hovered over.

12. A method as recited in claim 10, further comprising:
detecting a hovering over one of the proxies in the first display area; and
displaying, in response to detecting the hovering over one of the proxies, a reduced size image of a card corresponding to the one proxy being hovered over.

13. A method as recited in claim 10, further comprising:
receiving an additional user input selecting one proxy of the set of proxies corresponding to a particular one card of the set of cards; and
changing, in response to the additional user input, to displaying a second subset of the set of cards in the first display area, the second subset of cards including the particular one card.

14. A method as recited in claim 10, the sorting including changing, in response to the user input, to displaying a second subset of the set of cards in the first display area, the second subset of cards including a card of the set of cards corresponding to the one of the proxies as well as one or more other cards absent from the first subset of cards.

15. A computing device comprising:
a card display module configured to display, in a first display area of a user interface, a first subset of a set of cards in a particular order relative to one another;
a proxy display module configured to display, in a second display area of the user interface, a set of proxies in a particular order relative to one another, each proxy corresponding to a card of the set of cards and the set of proxies including a proxy for each card in the set of cards;
an input module, implemented at least in part in hardware, configured to receive a user input to change a location of one of the proxies in the particular order in the second display area;
the card display module being further configured to change, in response to the user input, the particular order of the first subset of cards in the first display area based on the changed location of the one proxy; and
the proxy display module being further configured to change, in response to the user input, the particular order of the set of proxies displayed in the second display area.

16. A computing device as recited in claim 15, the card display module being further configured to receive a notification of the change of location of the one of the proxies and being further configured to change the particular order of the first subset of cards in response to the notification.

17. A computing device as recited in claim 15, the user input comprising dragging and dropping the one proxy in the second display area.

18. A computing device as recited in claim 15, the proxy display module being further configured to detect a hovering over one of the proxies in the first display area, and to display, in response to detection of the hovering over one of the proxies, a name of a card corresponding to the one proxy being hovered over.

19. A computing device as recited in claim 15, the proxy display module being further configured to detect a hovering over one of the proxies in the first display area, and to display, in response to detection of the hovering over one of the proxies, a reduced size image of a card corresponding to the one proxy being hovered over.

20. A computing device as recited in claim 15, the proxy display module being further configured to receive an additional user input selecting one proxy of the set of proxies corresponding to a particular one card of the set of cards, and to change, in response to the additional user input, to display a second subset of the set of cards in the first display area, the second subset of cards including the particular one card.

21. A computing device as recited in claim 15, the card display module being further configured to change, in response to the user input, to display a second subset of the set of cards in the first display area, the second subset of cards including a card of the set of cards corresponding to the one of the proxies as well as one or more other cards absent from the first subset of cards.
